(19) United States
(12) Patent Application Publication
(10) Pub. No.: US 2012/0072170 A1
(43) Pub. Date: Mar. 22, 2012

(54) VISION MEASUREMENT PROBE AND METHOD OF OPERATION

(75) Inventors: Alexander David McKendrick, East Kilbride (GB); Ian William McLean, Edinburgh (GB); Calum Conner McLean, Edinburgh (GB); Nicholas John Weston, Peebles (GB); Timothy Charles Featherstone, Edinburgh (GB)

(73) Assignee: RENISHAW PLC, Wotton-Under-Edge, Gloucestershire (GB)

(21) Appl. No.: 13/322,044

(22) PCT Filed: Jun. 4, 2010
(86) PCT No.: PCT/GB2010/001088

§ 371 Date: Nov. 22, 2011

(30) Foreign Application Priority Data
Jun. 4, 2009 (GB) 0909635.5

(51) Int. Cl. G01B 11/00; G06F 15/00

(52) U.S. Cl. 702/150

(57) ABSTRACT

A method of operating a vision measurement probe for obtaining and supplying images of an object to be measured. The vision measurement probe is mounted on a continuous articulating head of a coordinate positioning apparatus, and the continuous articulating head having at least one rotational axis. The object and vision measurement probe can be moved relative to each other about the at least one rotational axis and in at least one linear degree of freedom during a measuring operation. The method includes: processing at least one image obtained by the vision measurement probe to obtain feedback data; and controlling the physical relationship between the vision measurement probe and the object based on said feedback data.

The present invention relates to a vision measurement probe, such as a video or camera probe, that obtains images of an object to be measured and a method of its use within a measuring apparatus. In particular, the invention relates to a method of analysing images taken by the vision measurement probe and using a processor to generate quantities which can be used for real time control of the measuring apparatus.

When manufacturing parts, such as those for use in the automotive or aeronautical industries, it is often desirable to determine that those parts have been manufactured to within desired tolerances. Conventionally, the dimensions of features of a part are determined by mounting the part on a coordinate measuring machine and bringing a touch probe mounted on the coordinate measuring machine into contact with the features of interest. The coordinates are taken of different points around the feature, thereby enabling its dimensions, shape, and/or orientation to be determined.

Coordinate positioning machines typically comprise a base on which an artefact to be inspected can be supported, a frame mounted on the base for holding a quill which in turn is suitable for holding, for instance, an artefact inspection device for inspecting the artefact. The base, frame and/or quill are typically configured such that the inspection device, such as a measurement probe, and artefact can be moved relative to each other along at least one axis, and more typically along three mutually orthogonal axes X, Y and Z. Motors can be provided for driving the inspection device held by the quill along those axes. It is also known to provide an articulating head onto which the inspection device is mounted. An articulating head typically has one, two or more rotational degrees of freedom so as to enable an inspection device mounted on the probe head to be moved about one, two or more axes of rotation. Such articulating heads are for example described in EP0690286 and EP0402440.

EP0690286 describes an indexing probe head in which motors are used to move the inspection device between a plurality of predetermined, or “indexed”, orientations. Once the head is set in the desired position, inspection of a part is performed with the inspection device by moving the frame and/or quill of the machine.

WO9007097 describes a further type of articulating probe head which is a continuous articulating head. In this type of head, the orientation of the inspection device can be controlled to be at any of a continuous range of positions, i.e. as opposed to at one of a plurality of discrete indexable positions. As a result, much finer control over the orientation of the head is possible compared to indexing heads. Often, continuous articulating heads are “active” or “servoing” heads in that the motor(s) of the active head is constantly servoed in order to control the orientation of the inspection device, e.g. either to hold the orientation of the inspection device or to change the orientation of the inspection device, for instance whilst measurements are taken. However, as will be understood, rather than being constantly servoed, it is possible to have a continuous articulating head which can be locked in position without the need for constant servoing.

Use of a touch probe has disadvantages. For instance, access can be limited (for example into very small bores) with touch probes. Furthermore, sometimes it is desirable to avoid physical contact with a part where parts have delicate surface coatings or finishes, or where parts are flexible and move significantly under the forces of a contact probe.

Existing non-contact imaging measurement probes can suffer from, for example, poor accuracy, limited field of view, and restrictions from weight and/or large size.

This invention provides an improved vision measurement probe system and an improved method of operating a vision measurement system.

This application describes a method for inspecting an object using a vision measurement probe, in which the object and vision measurement probe are moveable relative to each other. The method comprises processing at least one image obtained by the vision measurement probe to obtain feedback data. The method can also comprise processing at least one image obtained by the vision measurement probe so as to identify and obtain metrology data regarding at least one feature of the object. The method can further comprise controlling the operation of the vision measurement probe on the basis of the feedback data.

According to a first aspect of the invention there is provided a method of operating a vision measurement probe for measuring an object, the vision measurement probe being mounted on a coordinate positioning apparatus and in which the object and vision measurement probe are moveable relative to each other in at least one linear and/or at least one rotational degree of freedom during a measuring operation, the method comprising: processing at least one image obtained by the vision measurement probe to obtain feedback data; and controlling the physical relationship between the vision measurement probe and the object based on said feedback data.

The present invention is particularly concerned with the type of vision measurement probes that obtain, and can supply to a third party system, such as an image processor and/or end user, images of an object to be inspected, so that image processing techniques, for instance feature recognition techniques, can be used during image processing so as to obtain metrology data regarding the object. As will be understood, with vision measurement probes, metrological data regarding the object can be obtained from at least one image of the vision measurement probe (and for example from only one image of the vision measurement probe) and knowledge of position of the vision measurement probe only. Such vision measurement probes are typically referred to as video measurement probes, or camera measurement probes, and herein collectively referred to as vision measurement probes. This is in contrast to known non-contact measurement triangulation probes that project a structured light beam (such as a line) onto the object and, through knowledge of the position of and angle between the projector and camera, analyse the positional deformation of the structured light by the object to obtain measurement information via triangulation. In particular, the present invention enables feedback control for non-triangulation non-contact probes.

Suitable vision measurement probes typically comprise a window and a detector arranged to detect light entering the window. Preferably the detector is a two-dimensional detector, i.e. it has pixels extending in two dimensions, such that two-dimensional images can be obtained. Vision measurement probes also typically comprise a lens for forming an image onto the detector. Such vision measurement probes typically capture an image of an object to be measured and supply it to an external system, e.g. a metrology system, for metrology analysis. Vision measurement probes also typically comprise at least one light source for illuminating the object to be inspected. The vision measurement probe can comprise at least one light source for providing illumination across substantially all of the detector's field of view. Optionally, the vision measurement probe can comprise at least one light source for illuminating only a select region of the detector's field of view. For instance, the at least one light source could be configured to provide a spot illumination.

The method can comprise processing at least one image obtained by the vision measurement probe so as to identify and obtain metrology data regarding at least one feature of the object. As will be understood, the at least one image processed to identify and obtain metrology data can be the same image or a different image to the at least one image that is processed to obtain feedback data.

A metrology system could be provided for processing at least one image to obtain metrology data. The metrology system could be physically separate to the probe, and furthermore could be physically separate to any controller for controlling the operation of the coordinate positioning apparatus.

Metrology data could comprise data regarding the location of at least one point of the object within a measurement volume, for instance within a three dimensional coordinate space. For example, metrology data could comprise the size and/or location of features on the object, such as an edge of an object, or a hole in an object. Metrology data could also comprise data regarding the surface finish of the object, such as the roughness or the presence of any defects on the surface of the object. As will be understood, the metrological data could be obtained via combining data extracted from at least one the image of the vision measurement probe and data indicative of the position of the at least one vision measurement probe. As will be understood, such data indicative of the vision measurement probe could come from position sensors on the coordinate positioning machine.

Controlling the physical relationship can comprise moving at least one of the object and vision measurement probe. Controlling the physical relationship can comprise altering at least one of the relative position and orientation of the vision measurement probe and object.

As will be understood, the vision measurement probe and object could be held in a static relationship to each other, and the method can be used to alter the static relationship. This might be the case when the vision measurement probe and object are moved to at least one relative position and orientation, stopped and then an image taken which can be used to measure the object.

Altering the physical relationship might be done, for instance, for metrology reasons, i.e. so as to improve the suitability of the image(s) supplied by the vision measurement probe for obtaining measurement information therefrom. For example, it might be done so as to improve the quality of the image obtained by the vision measurement probe. For instance, the relative position and/or orientation of the vision measurement probe might be altered to reduce the extent of shadows, or to increase the degree of focus of at least a part of the object in the field of view of the vision measurement probe.

The vision measurement probe can be mounted on an articulating head having at least one rotational axis. In this case, the method can comprise reorienting the vision measurement probe about said at least one axis based on said feedback data. Preferably, the articulating head is a continuous articulating head. Accordingly, preferably the articulating head is a non-indexing articulating head.

The object and the vision measurement probe can be configured to move relative to each other in a predetermined manner during a measurement operation. Accordingly, controlling the physical relationship between the vision measurement probe and the object can comprise altering the predetermined relative movement between the vision measurement probe and the object based on said feedback data. In other words, controlling the physical relationship can comprise adjusting the predetermined relative motion based on said feedback data. Altering the predetermined relative movement can comprise adjusting a predetermined trajectory of relative movement between the vision measurement probe and the object based on the feedback data. Optionally, said altering can comprise adjusting the relative predetermined velocity of motion between the vision measurement probe and the object.

As will be understood, feedback data can be data indicative of the state of the vision measurement probe. The state of the vision measurement probe could comprise conditions of the vision measurement probe such as its position and/or orientation relative to the object (or even a particular feature of the object) being measured. In particular, the state of the measurement probe could comprise the quality of at least one of the images the vision measurement probe is obtaining.

Preferably, the feedback data is quantitative. In particular, preferably the feedback data has a quantity, or a value, which can be used to determine how to control the physical relationship between the object and vision measurement probe. This could be, for instance, in contrast to a simple two-state, e.g. an “OK” or “NOT OK”, feedback signal which might be used to continue or halt operation of the coordinate positioning apparatus.

The feedback data can comprise and/or relate to at least one property of at least a part of an image. The property can relate to at least one of the: contrast, brightness or focus of at least a part of the image. Accordingly, the feedback data can comprise and/or relate to at least one quantity, or value, relating the at least one property of at least a part of an image.

More particularly, the feedback data can comprise and/or be based on at least one parametric description of a property of the image. Accordingly, the feedback data is preferably not based on a determination of dimensional information of the object and does not require calculation of the relative geometrical relationship of the object and probe. Therefore, preferably the present invention enables feedback control for non-contact probes without having to determine the dimensional properties of the object or, for instance, the geometrical relationship between the Vision measurement probe and the object being measured, e.g. without having to determine their actual relative positions and orientations.

A parametric description can relate to at least one property of at least a part of an image. The property can relate to at least one of the: contrast, brightness or focus of at least a part of the image. A parametric description of a particular property of the image may comprise at least one parameter describing the form of a region of, for instance, at least one of: high brightness, high focus or high contrast in the image. The parametric description of the image may be calculated on the raw image data. For instance, the image could be pre-processed using a filter. The image can be pre-processed using an image processing filter. The image could be pre-processed to give a particular property map of the image. For example, the image could be pre-processed to give a measure of at least one of focus, brightness or contrast of a plurality of sections of, and optionally substantially all of, the image, i.e. a focus, brightness or contrast map of at least a part of the image. Parameters describing regions of high focus, brightness or contrast could be calculated on such a pre-processed image. The property map could have a lower resolution than that of the image. For instance, a group of image pixels could be processed to provide one property value. Filters could also be used to pre-process the image to measure the level of contrast or brightness present within each part of the image or other property which may be of interest.

The feedback data could comprise and/or be based on at least one parameter which describes at least one of: i) the principal axes of any region of interest having a particular property; ii) the first image moments of the region of interest, giving centre of gravity of the image with respect to a particular property; iii) other moments of the image with respect to a particular property, calculated about the principal axes. For instance, the feedback data could comprise the second image moments (i.e. the variance of the property) and/or the third image moments (i.e. the skewedness of the distribution of the property) of the region of interest. As will be understood, the principal axes (also commonly known as the principal component vectors, or the major and minor axes) are the best fit orthogonal vectors which correspond to the longest and shortest axes of the region of interest. As mentioned above, the particular property can comprise at least one of: high brightness, contrast, focus or other property of the image. Whether or not a part of an image has a high brightness, contrast, focus or other property can be established using standard image processing techniques, and can include determining whether the property of interest at a particular pixel or group of pixels meets a predetermined threshold.

The feedback data can comprise a desired movement vector between the optical measurement device and object.

The vision measurement probe can comprise the at least one processor and can be configured to process at least one image obtained by the vision measurement probe to obtain the feedback data. This can be advantageous as it can avoid the need to transmit an image over a communications link to a processor for generation of the feedback data. Feedback data is typically less voluminous than the image data and so takes less time to transmit and consumes less bandwidth. Accordingly, when the feedback data is being used in the real-time control of the object inspection apparatus probe it can be advantageous to obtain the feedback data using a processor in the probe.

The method could comprise controlling the physical relationship between the vision measurement probe and object in order to alter the amount of light detected by the vision measurement probe. For instance, this could be to increase or decrease the amount of light detected by the vision measurement probe. Optionally, this could be to avoid flooding of the sensor with too much light which can cause a drop in the level of detail which can be captured by the vision measurement probe.

The vision measurement probe can be a fixed focus system. In particular, the vision measurement probe can have a fixed focal plane relative to the vision measurement probe's image sensor. Optionally, the vision measurement probe can have a fixed depth of field. This is in contrast to vision measurement probes which can adjust at least one of the distance between the focal plane and the vision measurement probe, and its depth of field. Preferably, the distance between the focal plane and the vision measurement probe's image sensor is not greater than 350 mm, more preferably not greater than 250 mm, especially preferably not greater than 100 mm. Preferably, the distance between the focal plane and the vision measurement probe's image sensor is not less than 10 mm, for instance not less than 50 mm. Preferably the depth of field of the vision measurement probe is not less than 5 μm. As explained in more detail below, it can be preferred in certain embodiments that the depth of field is very shallow. This might be such that accurate information regarding the distance between the vision measurement probe and the surface object can be obtained (commonly known as “height” or “offset” position information). In such cases, it can be preferred that the depth of field of the vision measurement probe is not more than 1 mm, preferably not more than 500 μm, more preferably not more than 100 μm, especially preferably not more than 50 μm, for example not more than 10 μm.

The method can comprise controlling the physical relationship between the vision measurement probe and object in order to alter the state focus of the object, e.g. the state of focus of the object in the vision measurement probe's image plane. In particular, this can be useful to keep a particular part of the object in focus and/or to keep the in-focus region within a particular region of the image(s) obtained by the vision measurement probe.

The method can comprise controlling the velocity of motion between the vision measurement probe and object based on the state of focus of the object. In particular, the relative velocity of the vision measurement probe and object can be dependent on the rate of change of sharpness (i.e. degree of focus). In particular, the method can comprise moving the vision measurement probe and object relative to each other at at least a given velocity when the rate of change of sharpness of at least a part of an object as imaged is high, e.g. exceeds a threshold, and at less than the given velocity when the rate of change of sharpness is low, e.g. does not meet the threshold value. In other words, the method can comprise moving the vision measurement probe and object relative to each other at a high velocity when the rate of change of sharpness of at least a part of an object as imaged is high, and at a low velocity when the rate of change of sharpness is low. In a particular embodiment, the relative velocity could be proportional to the rate of change of velocity. The method could comprise controlling relative motion to be not greater than a given velocity until a threshold rate of change of sharpness is first exceeded. Optionally, the relative velocity of the vision measurement probe and object can be dependent on the rate of rate of change of sharpness (i.e. the second derivative of the degree of focus). In particular, the method can comprise moving the vision measurement probe and object relative to each other at at least a given velocity when the rate of rate of change of sharpness of at least a part of an object as imaged is high, e.g. exceeds a threshold, and at less than the given velocity when the rate of change of sharpness is low, e.g. does not meet the threshold value. In particular, the absolute relative velocity can be controlled to be proportional to rate of change of the sharpness when the rate of rate of change of sharpness of at least a part of an object as imaged is high, e.g. exceeds a threshold. Furthermore, the position of optimum focus can be found by determining when the rate of rate of change of sharpness (i.e. the second derivative of sharpness) is high (e.g. has a value, optionally is greater than a threshold, for example when it is substantially at a maximum) and when the rate of change of sharpness (i.e. the first derivative of sharpness) is low, for example, substantially zero.

The feedback data is preferably obtained at a higher priority than the metrology data. Accordingly, not only can metrology data regarding the object be obtained from images obtained by the vision measurement probe, but also feedback data can be obtained at a higher priority. It can be useful to have such feedback data as it can be used in the automatic control and/or monitoring of the vision measurement probe.

The feedback data can be obtained on a substantially real-time basis. The feedback data can be obtained, and said altering can be performed, on a real-time basis. That is, the feedback data can be obtained in a regular time constrained manner. Accordingly, the at least one processor can be for processing at least one image obtained by the vision measurement probe to obtain real-time feedback data. This can be advantageous because, if desired, the data can be used in the real-time control of the object inspection apparatus, such as the real-time control of the vision measurement probe, as explained in more detail below. In particular, the delay between an image being captured and the physical relationship being controlled on the basis on the feedback data obtained from that image is ideally not more than 200 ms, preferably not more than 100 ms, more preferably not more than 50 ms, especially preferably not more than 33 ms, for example not more than 25 ms.

Optionally, the feedback data could be for use by a controller (described in more detail below) to automatically determine how to control the physical relationship between the vision measurement probe and the object. Accordingly, the method can comprise a controller controlling the physical relationship between the vision measurement probe and the object based on said feedback data. The feedback data could merely comprise a control instruction for execution by the controller. For instance, the feedback data could comprise a movement vector instruction for a controller. For instance, the movement vector instruction can tell a controller how to control the object inspection apparatus so as to change the relative position, orientation and/or velocity of the object and vision measurement probe.

The vision measurement probe could comprise a processor that is configured to process at least one image so as to obtain the metrology data. Optionally, the object inspection apparatus further comprises a metrology system configured to receive at least one image from the vision measurement probe. The metrology system preferably comprises at least one of the at least one processors. Optionally, the metrology system is configured to perform feature recognition (e.g. using normalised greyscale correlation) to identify at least one feature of the object measured and in which metrology data is obtained regarding the at least one identified feature.

In embodiments in which the vision measurement probe comprises a processor, the processor could be used to divide up the image processing workload between a plurality of processors of the optical inspection apparatus.

The feedback data can be obtained at a higher priority than the metrology data.

Preferably, the feedback data is generated (and optionally supplied to a controller) at a higher priority than that at which an image is supplied to a metrology system for analysing the image to obtain metrology data. Accordingly, in embodiments in which the vision measurement probe comprises at least one processor for generating the feedback data, preferably the vision measurement probe is configured to generate and supply the feedback data at a higher priority than the supply of the image. In particular, preferably, the vision measurement probe is configured to begin generating the feedback data prior to supplying the image to a metrology system. For example, the vision measurement probe could be configured to generate and transmit the feedback data to the controller prior to transmitting the image to the metrology system. The optical measurement could be configured to compress the image prior to it being supplied to the metrology system. In this case, the vision measurement probe could be configured to generate the feedback data prior to compressing the image.

As will be understood, a coordinate positioning apparatus could comprise for instance, a non-cartesian measuring apparatus such as a parallel kinematic system, cartesian measuring apparatus such as a coordinate measuring machine (CMM)) or other types of coordinate position apparatus such as robot arms on which the vision measurement probe can be mounted.

The invention also provides an object inspection apparatus comprising: a vision measurement probe for obtaining images of an object to be inspected; at least one processor for processing at least one image obtained by the vision measurement probe to obtain feedback data.

For example, this application describes an object inspection apparatus comprising: a vision measurement probe for obtaining images of an object to be inspected; and at least one processor for i) processing at least one image obtained by the vision measurement probe to obtain feedback data and ii) processing at least one image of the object obtained by the vision measurement probe so as to identify and obtain metrology data regarding at least one feature of the object. Optionally, the feedback data could be for use by a controller (described in more detail below) to automatically determine how to control the operation of the object inspection apparatus during an inspection operation.

According to a second aspect of the invention there is provided an object inspection apparatus comprising: a coordinate positioning machine; a vision measurement probe for obtaining images of an object to be inspected for mounting on the coordinate positioning machine such that the object and vision measurement probe are moveable relative to each other in at least one linear and/or at least one rotational degree of freedom during a measuring operation; and at least one processor for processing at least one image obtained by the vision measurement probe to obtain feedback data indicative of the state of the vision measurement probe; and at least one controller for altering the physical relationship between the vision measurement probe and the object based on said feedback data.

The object inspection apparatus can comprise a controller for controlling the operation of the object inspection apparatus probe during inspection of an object. Preferably, the controller receives the feedback data and uses it to control the operation of the object inspection apparatus.

Preferably, the controller is a device for automatically controlling the relative movement between the vision measurement probe and an object being inspected. Preferably, the controller uses the feedback data in the control of the relative movement of the vision measurement probe and the object. Preferably, the controller is configured to adjust a predetermined trajectory of relative movement between the vision measurement probe and an object based on the feedback data. This can be useful when inspecting objects having substantially known dimensions, e.g. when comparing an object to a nominal object.

The vision measurement probe could comprise a processor that is configured to process at least one image so as to obtain the metrology data. Optionally, the object inspection apparatus further comprises a metrology system configured to receive at least one image from the vision measurement probe. The metrology system preferably comprises at least one of the at least one processors. Optionally, the metrology system is configured to perform feature recognition (e.g. using normalised greyscale correlation) to identify at least one feature of the object measured and in which metrology data is obtained regarding the at least one identified feature.

As will be understood, this specification describes an optical inspection apparatus comprising: a housing having a window; a light source; a detector arranged to detect light entering the window; a processor which receives an input from the detector.

Preferably the processor is arranged to provide real time feedback; this feedback may be based upon parametric descriptions which the processor extracts from the image on the detector. The property of interest in the image may be the level of contrast, degree of focus, brightness or some other attribute of the image. Parametric descriptions of a particular property of the image may comprise parameters describing the form of regions of, for instance, high brightness, high focus or high contrast in the image. The parametric descriptions of the level of high brightness of an image may be calculated on the raw image data. The image can be pre-processed using a particular filter to give a measure of focus of each part of the image, and it is on this pre-processed image that parameters describing regions of high focus could be calculated. Similar filters can be designed to pre-process the image to measure the level of contrast present within each part of the image or other property which may be of interest.

The processor may output feedback relating to the position and/or other parametric descriptions of the image on the detector and unprocessed data from the detector.

Parameters which can be used to describe the image might include: the principal axes of any region of high brightness, contrast, focus or other property; first moment of the region of high brightness, contrast, focus or other property, giving centre of gravity of the image with respect to that particular property; other moments of the image with respect to a particular property, calculated about the principal axes.

The processor may feedback to the controller, parameters describing the form of a particular property of the image on the detector and metrological data relating to the surface.

This specification also describes a method of measuring a surface with an optical probe, the method comprising: moving the optical probe along a trajectory relative to the surface; determining characteristics of a property or properties such as brightness, contrast or focus, of the image on the detector; adjusting the trajectory of the optical probe to keep the characteristics of the image within a defined range.

The characteristics of a property of the image may comprise the position of the region of high brightness within the image and the defined range may comprise an area on the detector. The position of a property of the image may comprise the position of a region of high focus. The position of a property of the image may comprise a region of high contrast.

Preferred embodiments of the invention will now be described, by way of example only, with reference to the accompanying drawings in which:

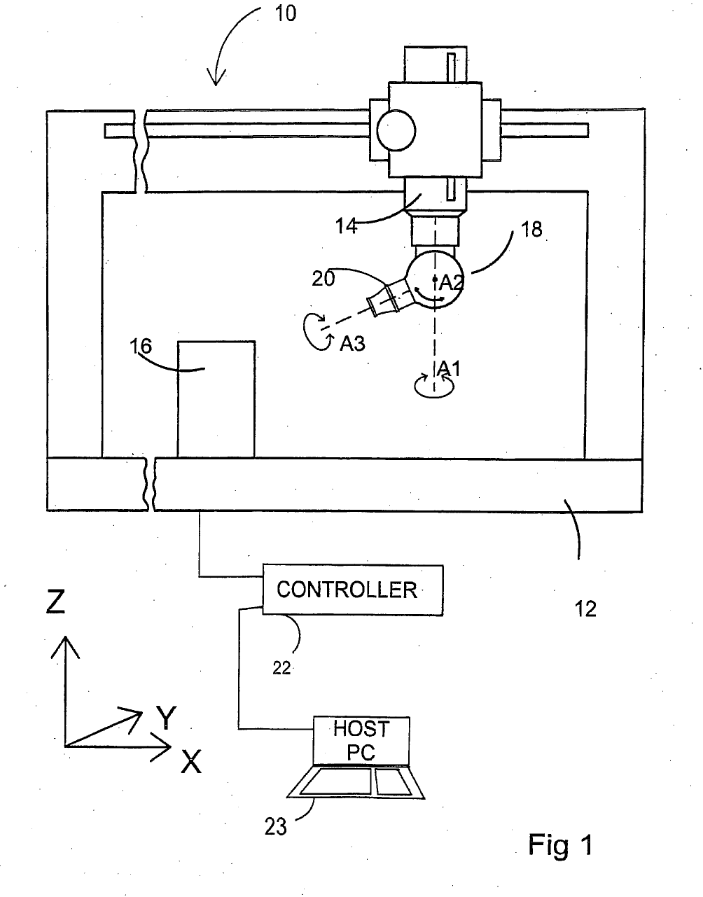

FIG. 1 illustrates a coordinate measuring machine with an articulating probe head and video probe mounted thereon;

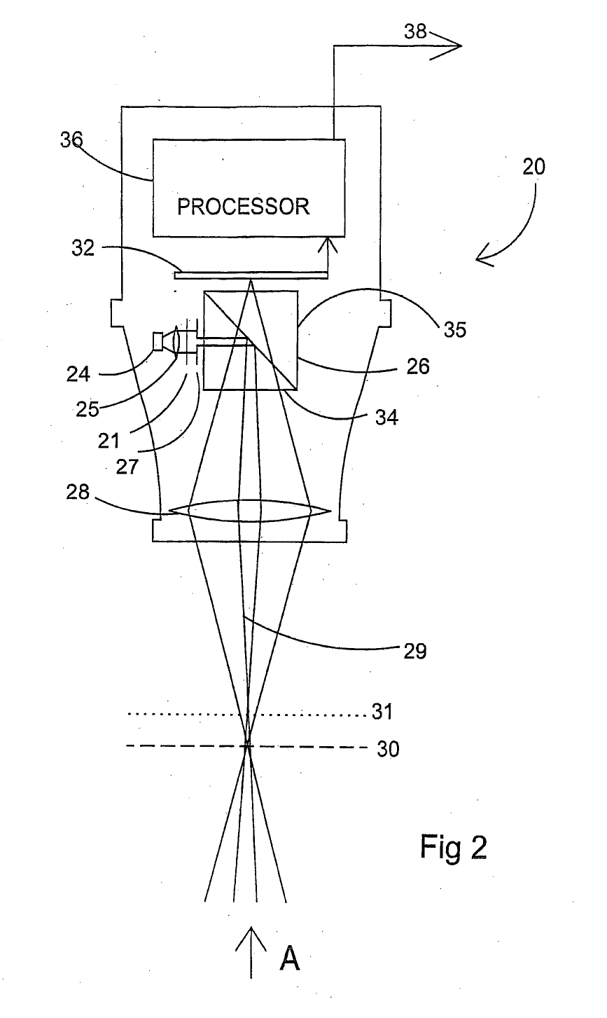

FIG. 2 illustrates the optical arrangement of the video probe illustrated in FIG. 1;

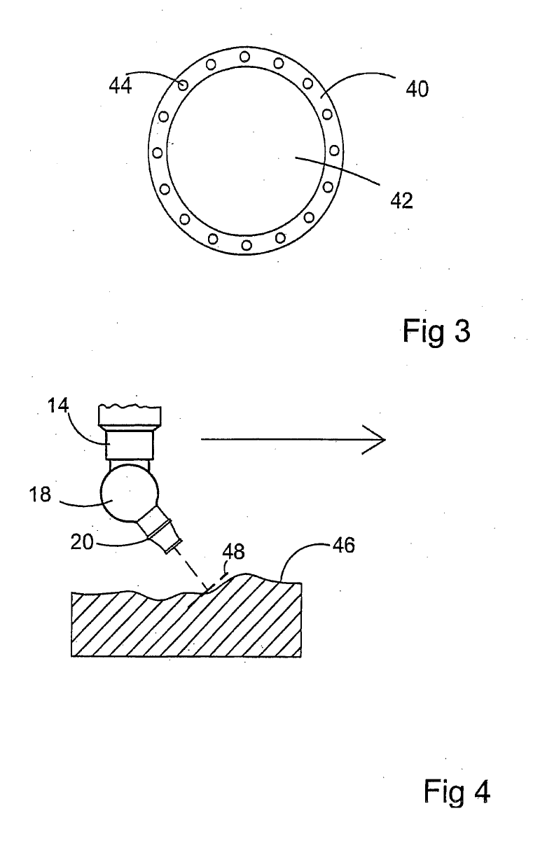

FIG. 3 illustrates an end face of the video probe of FIG. 2, showing the ring of LEDs;

FIG. 4 illustrates the video probe being moved along a trajectory relative to an undulating surface;

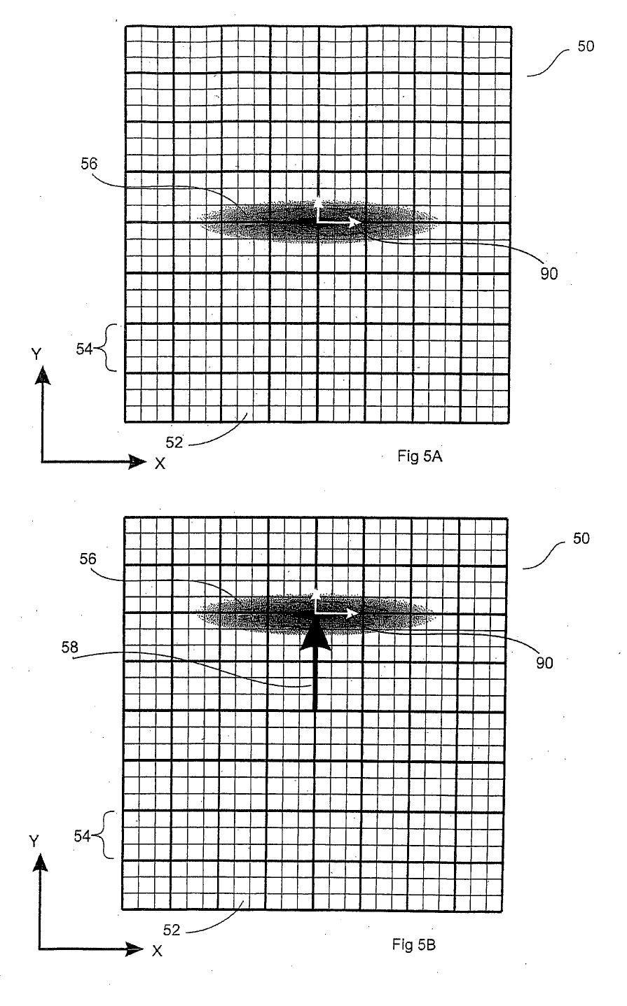

FIG. 5A illustrates the image on the detector of the video probe, showing the region of high focus;

FIG. 5B illustrates the image corresponding to FIG. 5A when the stand-off is reduced;

FIG. 5C illustrates the image corresponding to FIG. 5A when the stand-off is reduced and the plane of the part is at an angle and rotated about the optical axis of the probe;

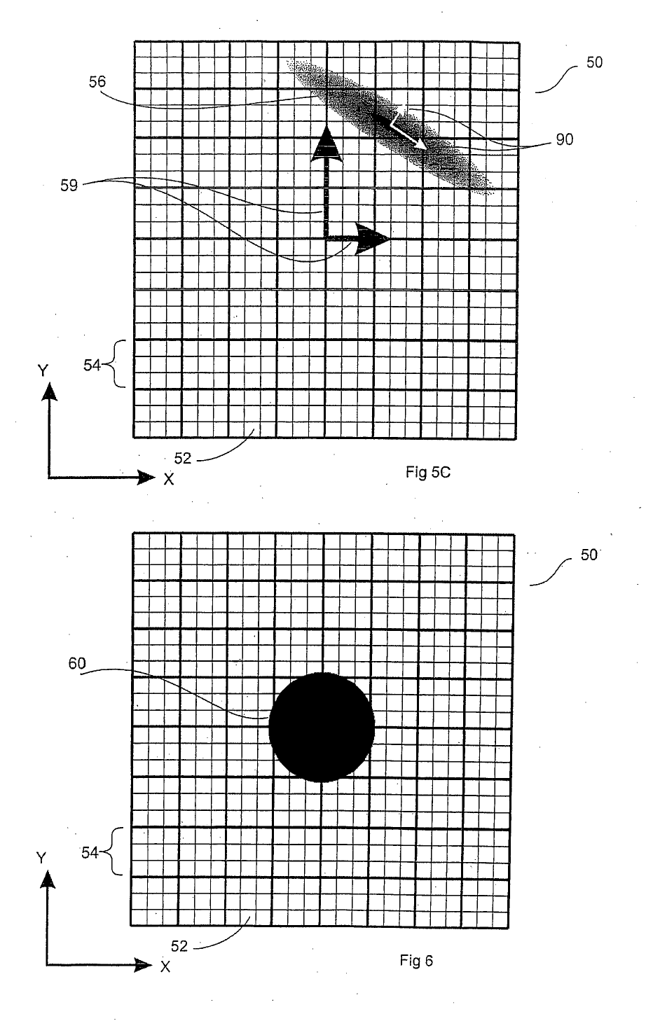

FIG. 6 illustrates the image on the detector of the video probe, showing the region of high contrast;

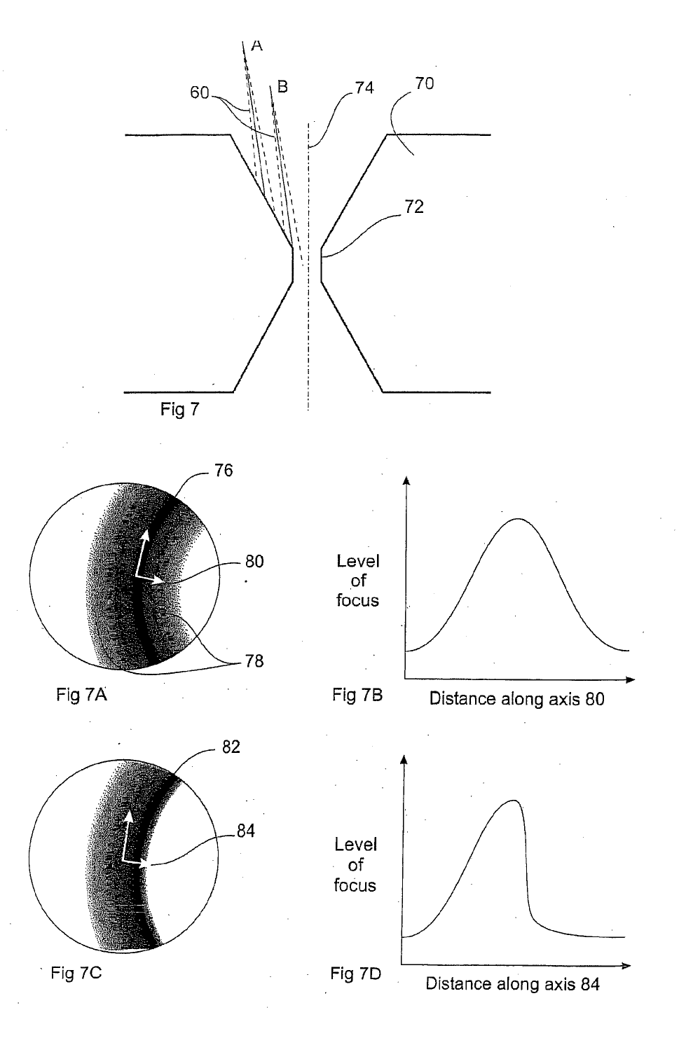

FIG. 7 is a cross section of a nozzle guide vane film cooling hole;

FIG. 7A illustrates the image of the TTLI area filtered to give a measure of the level of focus, when the probe is in position A of FIG. 7;

FIG. 7B is a graph showing the level of focus against the distance along the axis for the image of FIG. 7A;

FIG. 7C illustrates the image of the TTLI area filtered to give a measure of the level of focus, when the probe is in position B of FIG. 7;

FIG. 7D is a graph showing, the level of focus against the distance along the axis for the image of FIG. 7C;

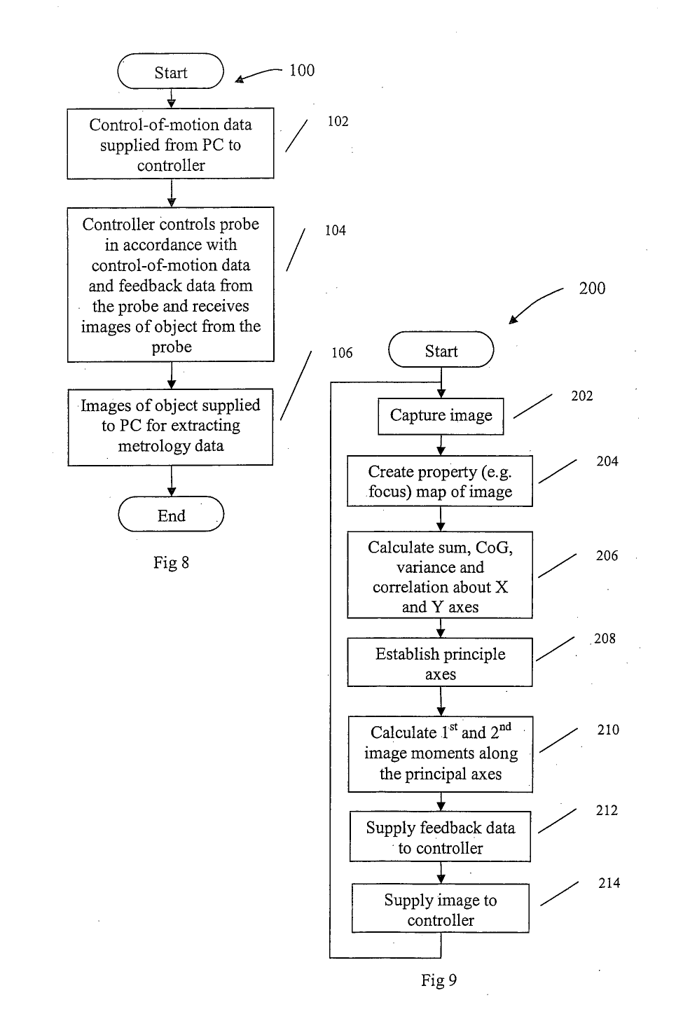

FIG. 8 is a high-level system flow chart;

FIG. 9 is a flow chart illustrating the process of operation of a vision measurement probe according to a particular embodiment of the invention; and

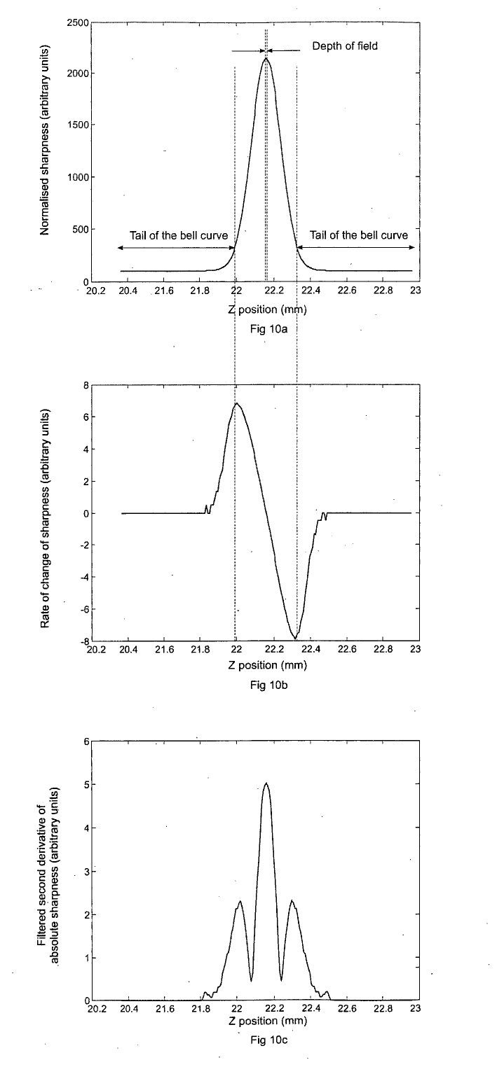

FIGS. 10(a), (b) and (c) illustrate nominal sharpness (i.e. degree of focus) of a surface of an object for a range of vision measurement probe offset distances, and first and second derivates of the nominal sharpness,

FIG. 1 illustrates an object inspection apparatus according to the invention, comprising a coordinate measuring machine (CMM) 10, a vision measurement probe 20, a controller 22 and a host computer 23. The CMM 10 comprises a table 12 onto which a part 16 can be mounted and a quill 14 which is movable relative to the table 12 in X, Y and Z. An articulating probe head 18 is mounted on the quill 14 and provides rotation about at least two axes A1, A2. The vision measurement probe 20 is mounted onto the articulating probe head 18 and is configured to obtain images of the part 16 located on the table 12. The vision measurement probe 20 can thus be moved in X, Y and Z by the CMM 10 and can be rotated about the A1 and A2 axes by the articulating probe head 18. Additional motion may be provided by the CMM or articulating probe head, for example the articulating probe head may provide rotation about the longitudinal axis of the video probe A3.

The desired trajectory/course of motion of the video probe relative to the part 16 is calculated by the host computer 23 and fed to the controller 22. Motors (not shown) are provided in the CMM 10 and articulating probe head 18 to drive the vision measurement probe 20 to the desired position/orientation under the control of the controller 22 which sends drive signals to the CMM 10 and articulating probe head 18. The positions of the CMM and articulating probe head are determined by transducers (not shown) and the positions are fed back to the controller 22.

The construction of the vision measurement probe 20 is shown in more detail in FIG. 2.

FIG. 2 is a simplified diagram showing the internal layout of a vision measurement probe. A light source 24, for example a light emitting diode (“LED”), produces a light beam and directs it towards lens 25, and on to a polarising filter 21, which is provided to produce a polarised light beam from the light source. This light source is then reduced in diameter by passing through aperture 27 and on to a polarising beam splitter 26. The beam splitter reflects the beam towards a lens 28 which focuses the light at a focal plane 31. The light continues on, now diverging, to the focal plane of the imaging system 30. Light scattered back from a surface passes through the lens 28 and beam splitter 26 and is focused onto a detector 32. The detector 32 is a 2D pixelated detector for example, a charge-coupled device (“CCD”). As will be understood, detectors other than CCDs can be used, for example a complementary metal-oxide-semiconductor (“CMOS”) array.

Advantageously, a polarised light source is used so that light from the light source is selectively reflected by a polarising beam splitter 26 towards the surface 30. Only a tiny fraction of the light passing through the beam splitter towards the lens 28 is reflected back by face 34 toward the detector 32—the majority of this spurious reflection is directed back towards the light source. Similarly only a tiny fraction of the light passes through to face 35, so reflections do not occur from this face either. Any bright spot on the camera which might be produced by reflections at faces 34 or 35 is thus reduced or removed. This arrangement also has the advantage that only illumination scattered, and therefore randomly polarised, by the surface is returned to the camera. Alternative configurations, for example using a non-cubic beam splitter to direct reflections away from the detector, are possible and are within the scope and spirit of this invention.

This layout is referred to as ‘through the lens illumination’ (TTLI). The aperture in the TTLI system means that the field of view of the imaging system is considerably larger than the area illuminated by the TTLI. This has the advantage that the light can be directed down a narrow bore without illuminating the surface of the part into which the bore is formed. Were light to fall on the surface into which the bore is formed it would be reflected much more effectively than by the side walls of the bore, and this reflected light would swamp the light returned by the feature of interest, namely that from the side walls of the bore. This is particularly the case where the camera probe has a shallow depth of field and the surface of the part into which the bore is formed is outside the depth of field. The position of each pixel in X and Y relative to a datum point, such as the detector centre, is known from calibration and thus the position of a detected image relative to the datum position can be determined. Further details of various alternative TTLI probe implementations are described in more detail in PCT application no. PCT/GB2009/001260. Subject matter disclosed in that application is incorporated into the specification of this application by this reference.

The lens 28 can be chosen to give the video probe a shallow depth of field, for example ±20 μm. If a surface is detected in focus, then its distance from the detector is known to within a range corresponding to the depth of field.

A processor 36 is also provided within the housing. The processor receives data from the detector and provides an output 38 to the controller 22 and computer 23.

As will be understood, a vision measurement probe 20 according to the invention need not comprise a TTLI arrangement. Indeed, the vision measurement probe need not necessarily comprise a light source. For instance, the object could be illuminated by ambient lighting. It will, however, be understood, that the vision measurement probe could also be operated in ring illumination mode. In this mode, the surface is illuminated by a ring of LEDs. FIG. 3 is a plan view of such a vision measurement probe in which it can be seen that the front face 40 of the housing of the vision measurement probe comprises a ring of LEDs 44 around a window 42.

As described, the vision measurement probe 20 is moved relative to a surface of a work piece by motion of the articulating probe head 18 and CMM 10 on which it is mounted. The position of the vision measurement probe 20 is preferably controlled to keep the surface in focus (which is particularly important with a shallow depth of field), and/or to keep the light spot on the correct part of the surface (for example on an edge of the object).

For an unknown part, or a known part deviating from its nominal dimensions, it is desirable to have feedback from the vision measurement probe to enable the position and orientation of the vision measurement probe to be adjusted in real time.

The process for generating feedback data will now be described in connection with FIGS. 4 to 9. Referring first to FIG. 8, there is shown a high-level system flow chart 100 of an example implementation of the invention. The general process of operation comprises at step 102 the PC 23 supplying to the controller 22 data which describes the desired course-of-motion of the video measurement probe 20. The course-of-motion data can comprise trajectory data as well as velocity data. The course-of-motion data can be generated automatically, for instance via analysis of a 3D computer model of the object to be inspected, or could be generated manually, for instance via an operator inputting a sequence of instructions.

At step 104, the controller 22 controls the operation of the CMM 10, including the operation of the articulating head 18 to drive the vision measurement probe 20 relative to the object being measured 16 in accordance with the course-of-motion data. At the same time, the controller 22 will be receiving feedback data (as explained in more detail below) which the controller uses to adjust in real-time its control of the relative motion between the vision measurement probe 20 and object 16 (as explained in more detail below). Furthermore, the vision measurement probe 20 obtains images and supplies them to the controller 22 during the measurement operation. As will be understood, the vision measurement probe 20 could be configured to buffer the images to be sent to the controller 22 in memory in the vision measurement probe and then supply the images to the controller 22 after the measurement operation.

At step 106, the controller 22 supplies the images received from the vision measurement probe 20 to the PC 23 which analyses them to obtained metrology data. As will be understood, the analysis performed by the PC 23 can vary widely depending on end-user's requirements. A particular example might involve pre-processing the images to normalise brightness and contrast in a region of interest. The analysis might then involve a two dimensional correlation of the image with a known pattern or patterns, followed by storing and/or reporting correlation data which may include a measure of the quality of the fit and the position, size and deviation from nominal of the correlating pattern.

As will be understood, many various other implementations of the invention are possible. For instance, the vision measurement probe 20 might store all of the images until the end of the measurement operation before transferring them to the controller 22. Furthermore, the vision measurement probe 20 might have a direct connection to the PC 23 and supply the images directly to the PC 23. In other embodiments, the PC 23 and the controller 22 might be one device.

FIG. 4 illustrates an example vision measurement probe 20, positioned at an oblique angle to a continuously varying surface 46. As described above, the vision measurement probe has a shallow depth of field. Where the surface 46 cuts the focal plane 48 of the video probe, the image will appear sharp. FIG. 5 illustrates the corresponding image on the detector.

FIG. 5 schematically illustrates a detector 50 comprising a two-dimensional array of pixels 52. An image of the object being inspected is captured across the entire detector, but because only a part of the object's surface lies on the focal plane (as illustrated in FIG. 4) only a region of the image is in focus. Highlighted region 56 corresponding to the part of the image that is substantially in focus (i.e. the focus values meet or exceed a predetermined focus value threshold). The image can be analysed by the processor 36 to determine where in the image plane (i.e. X, Y coordinates of detector) the in focus region lies.

As illustrated in FIG. 5A, the detector 50 is divided into segments 54. There may be, for example, 400 (20×20) pixels in each segment. The pixels in each segment are analysed to calculate a single value to quantify the level of a particular property, e.g. focus, present within that segment. The level of, for example, focus in each segment is thus assigned a numerical value, with the segments having the highest frequency content having the highest numerical value. Such analysis can comprise looking at the change in values between pixels in an image. This can be done, by for example, using a high pass-filter. In addition, a weighting factor can be used by passing the pixel values within a segment through a low pass filter (for example a boxcar filter, hamming filter or Gaussian curve). Once this has been done for all of the pixel segments 54, a focus map of image is obtained, albeit at a lower resolution than the original image. As will be understood, the detector need not be divided into segments and each pixel can be analysed to obtain a focus value for each pixel. The centre of gravity of the focus can thus be determined from the spread of numerical values (e.g. in the X, Y coordinates of the detector) in the focus map.

In this embodiment, the position of the centre of gravity along the Y coordinate can be used to determine the stand off between the vision measurement probe and the surface. With the vision measurement probe positioned obliquely to the surface as illustrated in FIG. 4, as the stand-off reduces, the centre of gravity will rise up the Y axis and as the stand-off increases, the centre of gravity will sink down the Y axis.

FIG. 5B shows the detector of FIG. 5A in which the stand-off has been reduced. The centre of gravity of the region of high focus has moved up the Y axis.

As will be understood by a person skilled in the art of image processing the calculation of image moments can be useful in the analysis of the distribution of various properties of an image. For instance, they can provide information about the distribution of the brightness, contrast or focus of the pixels across the image. As is known, the first moment of an image corresponds to the centre of gravity of the property of interest (e.g. the centre of gravity of the focus distribution), the second moment of an image corresponds to the variance of the property interest (e.g. the spread of the focus distribution), and the third moment of an image relates to the skewedness of distribution (e.g. how symmetrically spread the change in focus is across the image).

First, second and third image moments relate to the above properties along one axis of an image, and accordingly for a two dimensional image, image moments are typically calculated for each of two orthogonal axes. Furthermore, the image moments are typically calculated for the principal axes (also commonly referred to as to major and minor axes or principal components) of a particular property of interest in the image. As will be understood, the principal axes are typically the best fit orthogonal vectors which correspond to the longest and shortest axes of the region of interest. For instance, with reference to FIGS. 5A and 5B, the property of interest is focus, and the image has been filtered to provide a focus map as explained above. The focus map illustrates that there is a region in which the image is substantially in focus 56 and the principal axes 90 of the in focus region (i.e the region of interest) extend substantially along the X and Y axes of the image. In FIG. 5C however, the surface is at such an attitude to the vision measurement probe 20 such that the in-focus region extends at an angle across the detector. Accordingly, in this case, the principal axes of the in focus region 56 in FIG. 5C are not parallel to the X and Y axes of the image detector, but instead extend at an angle to them as illustrated by arrows 90. Calculating the second and third image moments along the principal axes provides more relevant and useful information than when calculated along the X and Y axes because the resulting results are at their least correlated, or to put it another way, most independent. Any action taken on the strength of one of these values will therefore have maximum effect on the value of interest, and minimum effect on the other value.

As will be understood, image moments can be calculated in the following way:

$${M}_{ij} = {\sum }_{x} {\sum }_{y} {x}^{i} {y}^{j} I ( x , y )$$

where i and j are the order of moment in the x and y axes respectively, M is a scalar representing the raw moment and I(x,y) represents themagnitude of the property of interest at the (x,y) position. This property could represent intensity, contrast or degree of focus, or other image information. The x,y coordinates could be relative to the image sensor; relative to the major and minor axes; or other arbitrary orthogonal axes. Accordingly, as will be understood:

| Moment | Description | Statistical analogy |
|---|---|---|
| M₀₀ | Sum of all values | Sum of all values in the data set |
| M₀₁ | First moment in Y | Mean of Y data |
| M₁₀ | First moment in X | Mean of X data |
| M₁₁ | Second moment in X Y | Correlation of X and Y |
| M₂₀ | Second moment in Y | Variance of Y data |
| M₀₂ | Second moment in X | Variance of X data |
| M₀₃ | Third moment in Y | Skewness of Y data |
| M₃₀ | Third moment in X | Skewness of X data |

It is useful to note that the principal (i.e. the major and minor) axes of the distribution of the property of interest in the image can be estimated by taking moments up to second order about the image sensor or other fixed arbitrary axes. In other words, the eigenvectors of the covariance matrix of the distribution of the property of interest are the principal axes. The covariance matrix can be constructed in the following way:

$${μ}_{20}^{′} = \frac{{M}_{20}}{{M}_{00}} - {( \frac{{M}_{10}}{{M}_{00}} )}^{2}$$

$${μ}_{02}^{′} = \frac{{M}_{02}}{{M}_{00}} - {( \frac{{M}_{01}}{{M}_{00}} )}^{2}$$

$${μ}_{11}^{′} = \frac{{M}_{11}}{{M}_{00}} - \frac{{M}_{10} \cdot {M}_{01}}{{M}_{00}^{2}}$$

$$cov [ I ( x , y ) ] = [ \begin{matrix}{μ}_{20}^{′} & {μ}_{11}^{′} \\ {μ}_{11}^{′} & {μ}_{02}^{′}\end{matrix} ]$$

The eigenvectors of this matrix can be found in the usual way.

Once the principal axis vectors are known subsequent moments can be calculated along these vectors and about the centre of gravity. This may be achieved by rotating the image to make Y correspond with, for example, the minor axis and X correspond with, for example, the major axis. This makes the moments invariant with translation and rotation, which is a desirable attribute in some circumstances.

FIG. 5C shows the detector of FIG. 5A in which the stand-off is reduced and the plane of the part is at an angle and rotated about the optical axis of the vision measurement probe. In this situation, the centre of gravity of the in focus line has moved across the detector.

The actual position of the centre of gravity on the detector or the actual position of the centre of gravity relative to some desired position of the centre of gravity on the detector can be fed back to the controller as feedback data. The controller can use this information to adjust the demand signals to the CMM 10 and/or articulating probe head 18 to bring the stand-off of the vision measurement probe back to the desired position of the centre of gravity on the detector. Accordingly, in many situations, the feedback data can simply comprise the position of the centre of gravity of the region of interest or this position relative to some desired position.

Under certain circumstances, the focus line may become very long and it can be difficult to determine the centre of gravity of the focus line. This can be detected by examining the magnitude of the second moment along the major axis, as described above. Where the second moment is large—i.e. there is a large variance along the major axis, it is possible that the calculated centre of gravity will vary considerably with noise in the image. It is desirable therefore to reduce the amount of correction along this axis which is applied to bring the centre of gravity back to the target position on the sensor, to reduce the effect of image noise on the servo demands used to track the surface. An example method of calculating feedback data will now be described with reference to FIG. 9. The process 200 of calculating feedback data begins at step 202 with the vision measurement probe obtaining an image.

The vision measurement probe's 20 processor 36 then at step 204 creates a property map (in this example a focus map) by performing analysis or filtering (as described above) to establish the level of a particular property (e.g. focus) of each of the image segments. At step 206, the centre of the detector is used as a zero position (or other arbitrary fixed point e.g. a chosen fixed point in coordinate frame/reference about which image moment values can be calculated), and the overall sum, the centre of gravity, variance and correlation (i.e. M₀₀, M₁₀, M₀₁, M₂₀, M₀₂, and M₁₁), of the distribution of the in-focus region about the X and Y axes of the image sensor (or other arbitrary fixed axis system) are calculated by the processor 36.

At step 208, the processor 36 establishes the principal (e.g. major and minor) axes 90 of the in focus region of the image from the covariance matrix (see above for more details). At step 210, the processor 36 uses the centre of the detector (or other arbitrary fixed point) as the zero position to calculate the first moments (that is the centre of gravity) of the in focus region about (i.e. in relation to) the principal axes. Furthermore at step 210, the processor 36 uses the centre of gravity as the zero position to calculate the second moments (that is the variance) of the in focus region about the principal axes (alternatively this may be derived from the previously calculated M₀₀, M₁₀, M₀₁, M₂₀, M₀₂, data with the centre of the detector as it's axis system).

Feedback data is then calculated and supplied to the controller 22 at step 212. In the embodiment described, the feedback data is based on the principal axis direction which has the smaller second moment and therefore represents the narrower aspect of the in focus region. The controller 22 then uses this feedback data to servo the CMM 10 or in particular the probe head's 18 axes in the direction of the selected principal axis in order to minimise the first moments. In this particular embodiment, at least one vector describing the principle axis could be reported as unit vector, in which case a magnitude scalar value for at least one axis of motion will be supplied.

Lastly, at step 214, the image obtained by the vision measurement probe is supplied to the controller 22. As will be understood, it is not necessary that all images obtained by the vision measurement probe are supplied to the controller. Furthermore, it is not necessary that any or all of the images supplied to the controller are the same as the images used to obtain feedback data.

Accordingly, the feedback data can comprise a position or a position relative to some desired position that allows a vector to be calculated which describes the required adjustment to bring the centre of gravity of the in focus line towards the desired position of the centre of gravity on the detector in the object plane of the probe. As will be understood, the feedback data could be the vector itself. FIG. 5B shows a vector 58 corresponding to such an adjustment vector. This vector can be converted into the CMM coordinate frame to provide an X, Y, Z adjustment and/or the probe head's co-ordinate frame to provide an angular adjustment.

Using one of the schemes described above, the stand-off of the vision measurement probe can be adjusted to compensate for a changing gradient of the surface of the work piece, automatically accounting for the angle of the surface to the detector.

Accordingly, in view of the above, it will be understood that depending on the circumstances, feedback data, which may be used as part of a control loop or other routine requiring rapid response include, and/or be based on, at least one of:
the overall sum of the distribution of the parameter of interest (i.e. M₀₀);
the first moments (i.e. M₁₀, M₀₁) in X and Y taken about the centre of the image or other fixed axis system (i.e. such that it is not translation invariant), which indicate the centre of gravity of the distribution of the parameter of interest in relation to the axes;
the second moments in X, Y and XY, (M₂₀, M₀₂, M₁₁) which indicate the variance and correlation of the distribution of the parameter of interest with respect to the chosen axes;
the covariance matrix or eigenvectors derived from it (or other similar derived information) which indicate the principal (i.e. the major and minor) axes of the distribution of the parameter of interest; and
the third moments (M₃₀, M₀₃) along the principal (i.e. the major and minor) axes and centred on the centre of gravity which give a measure of the degee of skewedness in the distribution of the parameter of interest.

For surface inspection of parts where nominal dimensions are in error to an extent larger than the depth of field of the camera, or when establishing the position and orientation of a part using a camera it may be important to move the vision measurement probe in order to rapidly focus the image. A typical current approach is to move at a fixed speed towards a specified end point, taking images as rapidly as possible. Plotting the degree of sharpness (focus) against distance from the part a bell curve is obtained with optimum focus being at the top of the bell curve, and out of focus being either side of this peak, in the tails of the curve when detail is entirely lost in any image due to lack of focus. With a limited rate at which images may be collected too high a speed of motion results in too few samples of the bell curve resulting in an inaccurate estimate of the position of the peak, and therefore a sub-optimal focus with a shallow depth of field camera. To overcome this problem a two pass scheme may be used. A high speed move establishes an approximate focus position and a second pass at a slower speed over a restricted range can improve the accuracy of the image focus.

An improved method uses feedback data to control the speed of motion according to how rapidly the degree of focus is changing within a region of interest and allows a move into focus with a single move and minimal overshoot. FIG. 10(a) shows a plot of the nominal sharpness (i.e. the degree of focus) against the offset distance between the vision measurement probe and the surface of an object, for a relatively flat surface. As shown, the plot is substantially in the form of a bell curve. In a simple embodiment, when operating between the tails of the bell curve, a high speed of motion can be used when the rate of change of sharpness is high and speed is reduced as the rate of change of sharpness reduces. This for instance could be done by analysing the first derivate of the focus feedback signal and looking for the zero-crossing point, i.e. where the rate of change of sharpness is zero, to determine optimum focus. Accordingly, as will be understood, the velocity of the vision measurement probe can be reduced as the zero-crossing point is approached. If the zero-crossing point is crossed, the vision measurement probe can be reversed to back track to the position of optimum focus.

As will be understood, if the nominal position of optimum focus is not known, then there can be some ambiguity because as shown in FIG. 10(b) the rate of change of sharpness is zero when the surface is completely out of focus, i.e. on either side of the bell curve. An improved method allows a nominal focus position with an effectively unlimited tolerance by means of considering the rate of rate of change of sharpness (i.e. second derivative as shown in FIG. 10(c)) as well as the rate of change of sharpness (first derivative as shown in FIG. 10(a)). At optimum focus (the peak of the bell curve) the first derivative will be low but the absolute value of the second derivative will be high, whereas beyond the range where the simple technique may be applied (in the tails of the bell curve) both first and absolute value of the second derivatives will be low. Fast motion is therefore used when first and absolute value of the second derivatives are low, slower motion when both increase, and speed proportional to the first derivative when the absolute value of the second derivative is high. Typically the tails of the bell can be sensitive to noise, so appropriate filtering and threshold selection is required.

Whether it be the simplest method or more sophisticated technique which is implemented, in the event the optimum focus is over-shot the rate of change of the degree of focus becomes negative, which logically results in the speed reversing, bringing the image back towards optimum focus. This mode of operation uses the feedback data to control speed rather than trajectory, and the controlling demand is based on the sequence of degree of focus data rather than on feedback data taken from a single image. This may be implemented by means of a simple focus measure parameter being reported by the vision measurement probe to the controller, which itself monitors the rates of change of focus in order to control speed. Alternatively the rates of change of the degree of focus may be calculated in the probe and returned as a feedback parameter, which the controller can act upon to control speed, or the probe may calculate a desired speed and return this as a feedback parameter. Whichever means is selected, it is not necessary to send the images on which the measurements are based back to the controller, meaning less data capacity is required and images on which to base the focus measurements may be more rapidly obtained. This means that a greater density of focus data points can be gathered for a given motion speed, so higher speeds may be attained, or greater focusing accuracy obtained irrespective of the data bandwidth available for recovering images from the probe.

The above described techniques relate to embodiments in which the focus of an image is used to obtain the feedback data. As is described below, similar techniques may be used when the vision measurement probe is used in its ‘through the lens illumination’ mode, as described with reference to FIG. 2. In this case a light spot is projected onto the work piece surface and the image of the light spot is analysed to provide feedback.

FIG. 6 illustrates the detector with an image of a light spot 60 reflected from the surface. When the video probe is in the through the lens illumination mode, the contrast of the image is analysed in place of the focus level.

When the part is near the focal range of the spot the detector normally has a bright image of the part of the spot that is in focus. The contrast between the bright part of the spot (which is the only part of the image illuminated and in focus) and the dark background can be used to determine the position of the image of the in focus spot on the detector. Hence instead of calculating focus for the image, brightness can be used, with the brightness values for pixels being processed in the same way as focusness values described previously.

When using the TTLI scheme described previously, the TTLI beam is conical in shape (29 in FIG. 2). Hence, the diameter of the spot will vary with the distance between the vision measurement probe and the part being illuminated. The distance to the surface can thus be found by determining the size of the spot using known image processing techniques. For example, a threshold and best-fit analysis may be performed with all or a selection of regular points to find the position of the spot.

To optimise the information gathered from a TTLI spot image, spot shape and spot size data can be combined. Spot shape information is more detailed for shallow depth of field imaging systems and spot size for deeper depth of field imaging systems and so some weighting can be applied according to the lens system when combining the data.

As with the previous embodiment, parameters calculated from the image of the spot can be used to provide feedback to the controller to adjust stand-off and angle of the video probe. As also with the previous embodiment, such parameters can be calculated from a filtered image of the light spot on the detector. In the previous embodiment the image was filtered to provide a focus map. A similar technique could be used in this embodiment to provide, for instance a contrast or brightness map.

As described below, a technique using image moments of the level of light intensity or of focus may be used to establish whether a region of an image is formed by the image plane intersecting with a continuous surface, or whether it intersects with a silhouette. FIG. 7 shows the inspection of a nozzle guide vane (“NGV”) film cooling hole, 70 and its metering section 72. It is advantageous to be able to automatically locate the probe in a position which puts such a feature's silhouette in focus when inspecting it. At position A the image of the TTLI area, filtered (using the above described technique) to give a measure of the level of focus (i.e, a focus map), is schematically illustrated in FIG. 7A. The in focus curve 76 is bounded on either side by regions where the level of focus drops smoothly away, 78. The cross section of the level of focus along axis 80 is shown in FIG. 7B. Note that the graph is approximately symmetrical about the peak value. The coordinate measuring machine then moves down along the general direction of the axis of the NGV cooling hole 74 keeping the in focus line within the centre of the TTLI spot using the technique described previously. As this motion is taking place the third moment is calculated for each image (which has been filtered to give a measure of the level of focus) along the principal axes, which is a measure of asymmetry or skewedness of the focus profile. The image of the TTLI at position B, after it has been filtered to give a measure of the level of focus, is shown in FIG. 7C. When this point is reached the silhouette is in focus. The cross section of the level of focus along axis 84 is shown in FIG. 7D. It can be seen that the graph is now much less symmetrical about the peak. At this point the level of focus at the centre of gravity and skewedness are at a maximum. Once located, the silhouette, or other similar feature can be followed by using the technique described below.

Note that it is also possible to perform similar analysis using only image intensity rather than level of focus as the quantity assessed for skewness etc. In this case the intensity is smoothly varying but the sign of variation depends upon the feature being assessed and how much light it scatters back to the probe. In cases where the surface has high scattering properties the image shown in FIG. 7A would change gradually from mid grey (intermediate intensity) to light grey (high intensity) and gradually back to mid grey, and that shown in FIG. 7C would go from mid grey, gradually to light grey and then suddenly to black. In cases where the surface has low scattering properties the image shown in FIG. 7A would change gradually from mid grey to dark grey (low intensity) and gradually back to mid grey, and that shown in FIG. 7C would go from mid grey, gradually to dark grey and then suddenly to black. These transitions can be identified by examining the rate of change or gradient of intensity, combined with thresholds for absolute intensity which indicate whether a surface is detected within a particular region (whether in or out of focus) or not, the thresholds being selected based on how much light the feature is known to scatter back to the probe.

Note also that when calculating a measure of the degree to which an area is focused, the application of a simple pass filter to establish level of focus can average out the skewedness shown in FIG. 7D. Where this type of analysis is to be performed it is advantageous to establish the ‘measure of focusness’ using a more sophisticated filter which preserves the sudden transitions, for example a wavelet analysis.

When measuring a feature, for example a silhouette or the edge of a bore, the form of the edge or silhouette in the image (or filtered image if degree of focus or other property is being used to make the feature distinctive) can be described by a polynomial or functional description for ease of processing. The function can be projected forwards to estimate where the edge will be along the proposed CMM and probe head trajectory. This can be combined with the feedback to target where the spot must be moved to, to move the laser spot in the same direction as the feature, to keep the edge or silhouette in the field of view. The polynomial or functional description parameters used may constitute feedback data.

As illustrated in FIG. 2, the video probe is provided with a processor 36. Without a processor, the video probe could output raw or compressed image data from the detector which is analysed by the controller. There are a number of disadvantages to this arrangement. First the probe system has no control over how much work the controller is doing and thus the speed at which it is working. Thus the controller cannot guarantee to analyse the data from the detector and provide feedback to the CMM and articulating probe head in real time. Second, sending image data in a timely manner, even when compressed, requires a high bandwidth communications link which is expensive and complex to implement. Thirdly, the greater the volume of data which must be sent, the greater the opportunity for errors to occur within the data through for example electrical noise or timing problems, so error detection and correction functions are required.

To overcome this, the processor 36 in the video probe can analyse the detector data to provide control feedback in real time. This has the further advantage that the image does not necessarily need to be sent from the probe to the controller, so there is no potential degradation of image data by compression which might be required in order to fit the images into the available bandwidth.

The processor may also perform metrology analysis of the data and output the metrology data along with the control feedback. Alternatively, the metrology analysis (which is not time critical) may be performed in the controller or host PC 23, in which case the raw detector data is output along with the control feedback (which is time critical). This has the advantage of less processing power being required by the processor 36, the work of control feedback, and metrology analysis being divided up between the probe, controller and host PC as processing power, communications bandwidth, latency and time critical nature of the analysis dictates.

The schemes described above refer to use of a vision measurement probe sensitive to visible light. As will be understood, the vision measurement probe could be sensitive to other forms of radiation at other wavelengths, for instance any wavelengths in the near ultraviolet to the far infrared range.

1. A method of operating a vision measurement probe for obtaining and supplying images of an object to be measured, the vision measurement probe being mounted on a continuous articulating head of a coordinate positioning apparatus, the continuous articulating head having at least one rotational axis, and in which the object and vision measurement probe are moveable relative to each other about the at least one rotational axis and in at least one linear degree of freedom during a measuring operation, the method comprising:
processing at least one image obtained by the vision measurement probe to obtain feedback data; and
controlling the physical relationship between the vision measurement probe and the object based on said feedback data.

2. A method as claimed in claim 1, further comprising processing at least one image obtained by the vision measurement probe so as to identify and obtain metrology data regarding at least one feature of the object.

3. A method as claimed in claim 1, in which controlling the physical relationship comprises altering at least one of the relative position and orientation of the vision measurement probe and object.

4. A method as claimed in claim 1, in which controlling the physical relationship comprises reorienting the vision measurement probe about said at least one axis based on said feedback data.

5. A method as claimed in claim 1, in which the object and vision measurement probe are configured to move relative to each other in a predetermined manner during a measurement operation, and in which controlling the physical relationship comprises adjusting the predetermined relative motion based on said feedback data.

6. A method as claimed in claim 5, in which said altering the predetermined relative motion comprises adjusting a predetermined trajectory of relative movement between the vision measurement probe and the object based on the feedback data.

7. A method as claimed in claim 5, in which said altering the predetermined relative motion comprises altering the relative predetermined velocity of motion between the vision measurement probe and object.

8. A method as claimed in claim 1, in which the feedback data is based on at least one parametric description of a property of the image

9. A method as claimed in claim 8 in which the property relates to at least one of the: contrast, brightness or focus of at least a part of the image.

10. A method as claimed in claim 8, in which the at least one parametric description relates to the centre of gravity of a particular region of interest.

11. A method as claimed in claim 8, in which the at least one parametric description comprises at least one parameter relating to the principal axes of a particular region of interest.

12. A method as claimed in claim 1 in which the feedback data comprises a desired movement vector between the optical measurement device and object.

13. A method as claimed in claim 1, in which the vision measurement probe comprises the at least one processor and is configured to process at least one image obtained by the vision measurement probe to obtain the feedback data.

14. A method as claimed in claim 1, comprising controlling the physical relationship between the vision measurement probe and object in order to alter the amount of light detected by the vision measurement probe.

15. A method as claimed claim 1 in which the vision measurement probe is a fixed focus system.

16. A method as claimed in claim 1, comprising controlling the physical relationship between the vision measurement probe and object in order to alter the state focus of the object in the vision measurement probe's image plane.

17. A method as claimed in claim 2 in which the feedback data is obtained at a higher priority than the metrology data.

18. A method as claimed in claim 1, in which the feedback data is obtained, and said altering is performed, on a real-time basis.

19. An object inspection apparatus comprising:
a coordinate positioning machine comprising a continuous articulating head having at least one rotational axis;
a vision measurement probe for obtaining and supplying images of an object to be inspected, for mounting on the continuous articulating head such that the object and vision measurement probe are moveable relative to each other about the at least one rotational axis and in at least one linear degree of freedom during a measuring operation; and
at least one processor for processing at least one image obtained by the vision measurement probe to obtain feedback data indicative of the state of the vision measurement probe; and
at least one controller for altering the physical relationship between the vision measurement probe and the object based on said feedback data.

20. An apparatus as claimed in claim 19, further comprising at least one processor for processing at least one image of the object obtained by the vision measurement probe so as to identify and obtain metrology data regarding at least one feature of the object

21. An object inspection apparatus as claimed in claim 19, in which the vision measurement probe comprises the at least one processor for obtaining the feedback data.

22. An object inspection apparatus as claimed in claim 19, in which the controller is configured to alter at least one of the relative position and orientation of the vision measurement probe and object.

23. An object inspection apparatus as claimed in claim 19, in which the controller is configured to control relative motion of the vision measurement probe and object in a predetermined manner during a measurement operation, and in which altering comprises altering the predetermined relative motion based on said feedback data.

24. An object inspection apparatus as claimed in claim 23, in which the controller is configured to adjust a predetermined trajectory of relative movement between the vision measurement probe and object based on the feedback data.

25. An object inspection apparatus as claimed in claim 23, in which the controller is configured to alter the relative predetermined velocity of motion between the vision measurement probe and object.

26. An object inspection apparatus as claimed in claim 20, further comprising a metrology system configured to receive at least one image from the vision measurement probe and comprising the at least one processor which is configured to process at least one image so as to obtain the metrology data.

27. An object inspection apparatus as claimed in claim 26, in which the feedback data is generated at a higher priority than that at which the at least one image is supplied to the metrology system.

28. An object inspection apparatus as claimed in claim 19, in which the feedback data comprises at least one parametric description that is based on at least one particular property of the image.

29. An object inspection apparatus as claimed in claim 28 in which the property relates to at least one of the: contrast, brightness or focus of at least a part of the image.

30. An object inspection apparatus as claimed in claim 28, in which the at least one parametric description comprises at least one parameter relating to the form of a region of interest of the image having a property meeting predetermined criteria.

31. A vision measurement probe for mounting on an articulating head of a coordinate positioning apparatus for capturing and supplying images of an object to be measured to an external metrology system, the vision measurement probe being configured to also generate and supply feedback data from at least one captured image.
